(19) United States
(12) Patent Application Publication
(10) Pub. No.: US 2022/0018455 A1
(43) Pub. Date: Jan. 20, 2022

(54) Fluid Flow Control Valve

(71) Applicant: Worcester Polytechnic Institute, Worcester, MA (US)

(72) Inventors: Marko Popovic, Worcester, MA (US); Ellen Clarrissimeaux, Worcester, MA (US); Julia D'Agostino, Worcester, MA (US); Shannon Moffat, Worcester, MA (US)

(21) Appl. No.: 17/388,677

(22) Filed: Jul. 29, 2021

Related U.S. Application Data
(63) Continuation of application No. PCT/US2020/017302, filed on Feb. 7, 2020.
(60) Provisional application No. 62/802,933, filed on Feb. 8, 2019.

(51) Int. Cl. F16K 11/16; F16K 11/18; F16K 31/04; F15B 15/10; F15B 13/04

(52) U.S. Cl. CPC F16K 11/168; F16K 11/185; F15B 13/0401; F15B 15/103; F16K 31/04

(57) ABSTRACT

The systems and methods for fluid flow control valve device, where the device may include a support structure, one or more fluid tubes associated with the support structure, tensioning element supported by the support structure and being rotatable about an axis point relative to the support structure in response to an application of force, and one or more threads, each extending between the tensioning element and the one or more fluid tubes, the one or more threads configured to provide sufficient tension to compress at least one of the one or more fluid tubes in response to tension generated due to the rotation of the tensioning element.

### CROSS-REFERENCE TO RELATED APPLICATION(S)

This application is a continuation application of PCT International Application No. PCT/US2020/017302, filed Feb. 7, 2020, which claims priority to and the benefit of U.S. Provisional Application No. 62/802,933, filed Feb. 8, 2019, the entirety of each of which are incorporated herein by reference.

### FIELD

The present disclosure relates to a fluid control valve suitable for controlling fluid flow through different channels. In particular, the present disclosure relates to a fluid control valve configured to control through which channel fluid flows and the amount of flow through the channel.

### BACKGROUND

Generally, a fluid control valve regulates the flow or pressure of a fluid through a conduit. Fluid control is very important in a variety of hydraulic or pneumatic systems. One such system is a hydraulically actuated exo-musculature that can be used to promote muscular rehabilitation, while allowing the user to wear the device comfortably with the body's natural movement in mind. A fully functional and comprehensive exo-musculature has the potential to provide assistive movement for entire human body by replacing the often cumbersome and limiting traditional robotic system. However, for such systems to function properly, it is important to be able to control the flow of fluid through the system. There is still a need for efficient, easy to use and inexpensive flow control valves.

### SUMMARY

In accordance with the present disclosure, a fluid flow control valve device is provided. The device includes a support structure, one or more fluid tubes associated with the support structure, a tensioning element supported by the support structure and being rotatable about an axis point relative to the support structure in response to an application of force, and one or more threads, each extending between the tensioning element and the one or more fluid tubes, the one or more threads configured to provide sufficient tension to compress at least one of the one or more fluid tubes in response to tension generated due to the rotation of the tensioning element.

In some embodiments, the device further includes a one or more ports, each configured to receive at least one of the one or more fluid tubes to establish a continuous fluid flow through the device when a fluid tube is uncompressed. In some embodiments, each of the one or more threads includes a pair of loops coupled together. In some embodiments, each pair the loops are coupled together using a barrel clasp. In some embodiments, the one or more fluid tubes further comprise outer sheathing to protect the fluid tubes from damage when under tension by the one or more threads. In some embodiments, the support structure further includes one or more control access points through which the one or more threads extend through to around an exterior surface of one of the one or more fluid tubes. In some embodiments, the one or more threads extend around an exterior surface of the one or more fluid tubes. In some embodiments, the one or more fluid tubes is compressed by the one or more threads when the tensioning element is in a neutral state and at least one of the one or more fluid tubes is uncompressed by at least one of the threads when the tensioning element is rotated about the axis point. In some embodiments, the device further includes one or more beads positioned on a surface of the tensioning element, the one or more beads configured to move along the surface of the tensioning element when the force is applied to the tensioning element. In some embodiments, each of the one or more threads are connected to one of the one or more beads.

In accordance with the present disclosure, a method for controlling fluid flow through a control valve is provided. The method includes coupling a first end of at least one fluid tube to a reservoir including a fluid and second end of the at least one fluid tube to a fluid flow control valve. The fluid flow control valve includes a tensioning element supported by the support structure and being rotatable about an axis point relative to a support structure in response to an application of force and at least one thread extending between the tensioning element and the at least one fluid tube, the least one thread configured to provide sufficient tension to compress the at least one fluid tube in response to tension generated due to the rotation of the tensioning element. The method also includes rotating the tensioning element in a first direction to cause the at least one thread to reduce the tension applied to the at least one fluid tube. The reduced tension is sufficient to allow fluid to flow between the reservoir and the fluid flow control valve through the at least one fluid tube.

In some embodiments, the at least one fluid tube is compressed by the at least one thread when the tensioning element is in a neutral state, the at least one fluid tube is uncompressed by the at least thread when the tensioning element is rotated about the axis point in the first direction, and the at least one fluid tube remains compressed by the at least thread when the tensioning element is rotated about the axis point in a second direction. In some embodiments, the device further includes controlling at least one of an actuator and a stiffness device with the fluid flow between the reservoir and the fluid flow control valve through the at least one fluid tube. In some embodiments, the device further includes sending a control signal to the fluid flow control valve to rotate the tensioning element about the axis point in the first direction to provide a fluid flow input from the reservoir to the actuator or the stiffness device. In some embodiments, the device further includes sending a control signal to the fluid flow control valve to rotate the tensioning element about the axis point in the first direction to provide a fluid flow output from the actuator or the stiffness device to the reservoir.

In accordance with the present disclosure, a system for hydraulically assisted wearable clothing is provided. The system includes a reservoir including an actuating fluid, multiple actuators, a fluid flow control valve in communication with the reservoir and the actuators for selectively supplying the actuating fluid to the actuators. The fluid flow control valve includes a support structure, one or more fluid tubes associated with the support structure, a tensioning element supported by the support structure and being rotatable about an axis point relative to the support structure in response to an application of force, and one or more threads, each extending between the tensioning element and the one or more fluid tubes, the one or more threads configured to provide sufficient tension to compress at least one of the one or more fluid tubes in response to tension generated due to the rotation of the tensioning element. When an actuator of the multiple actuators is pressurized by the fluid flow control valve to move the inner member to its expanded state, the pressurized actuator expands in the axial direction. When an actuator of the multiple actuators is de-pressurized by the fluid flow control valve to return the inner member to its relaxed state, the de-pressurized actuator contracts in the axial direction. The system also includes a controller in communication with the fluid flow control valve to control operation of the fluid flow control valve and pressurization and de-pressurization of the multiple actuators.

In some embodiments, the system further includes a rotary selector disposed between the fluid flow control valve and the actuators to enable the fluid flow control valve to selectively supply the actuating fluid to the actuators. In some embodiments, the system further includes a one or more ports, each configured to receive at least one of the one or more fluid tubes to establish a continuous fluid flow through the device when a fluid tube is uncompressed. In some embodiments, each of the one or more threads includes a pair of loops coupled together. In some embodiments, each pair the loops are coupled together using a barrel clasp. In some embodiments, the one or more fluid tubes further comprise outer sheathing to protect the fluid tubes from damage when under tension by the one or more threads. In some embodiments, the support structure further includes one or more control access points through which the one or more threads extend through to around an exterior surface of one of the one or more fluid tubes. In some embodiments, the one or more threads extend around an exterior surface of the one or more fluid tubes. In some embodiments, the one or more fluid tubes is compressed by the one or more threads when the tensioning element is in a neutral state and at least one of the one or more fluid tubes is uncompressed by at least one of the threads when the tensioning element is rotated about the axis point. In some embodiments, the system further includes one or more beads positioned on a surface of the tensioning element, the one or more beads configured to move along the surface of the tensioning element when the force is applied to the tensioning element.

In some embodiments, each of the one or more threads are connected to one of the one or more beads. In some embodiments, each of the multiple actuators includes an inner member made from an elastic material and having straight walls to define a straight, cylindrically shaped compartment for receiving an actuating fluid, the inner member being moveable in an axial direction from a relaxed state to an expanded state by introducing an actuating fluid into the inner member to pressurize the inner member and an outer member being disposed immediately adjacent to and around the elastic inner member to control expansion of the elastic inner member in a radial direction, the outer member being inelastic in the radial direction and expandable in the axial direction as the inner member moves from the relaxed state to the expanded state, the outer member being formed from a sheet of material such that the outer member forms an uninterrupted barrier such that there are no opening in the outer member in the expanded state to prevent the inner member from protruding through the outer member, wherein the outer member is configured to freely expand or contract in the axial direction along the inner member as the inner member moves between the relaxed state and the expanded state.

In accordance with the present disclosure, an exoskeleton is provided. The exoskeleton includes a wearable sleeve, a first member and a second member combined with the wearable sleeve, the second member being pivotably connected to the first member, an actuator connected to the first member at a first end of the actuator and to the second member at a second end of the actuator, a fluid flow control valve in communication with the reservoir and the actuators for selectively supplying the actuating fluid to the actuators. The fluid flow control valve includes a support structure, one or more fluid tubes associated with the support structure, a tensioning element supported by the support structure and being rotatable about an axis point relative to the support structure in response to an application of force, and one or more threads, each extending between the tensioning element and the one or more fluid tubes, the one or more threads configured to provide sufficient tension to compress at least one of the one or more fluid tubes in response to tension generated due to the rotation of the tensioning element. When the actuator is pressurized by the fluid flow control valve to move the actuator to its expanded state, the actuator expands in the axial direction. When the actuator is de-pressurized by the fluid flow control valve to return the actuator to its relaxed state, the actuator contracts in the axial direction to cause a movement of at least one of the first member and the second member relative to the other member.

In some embodiments, the exoskeleton further includes a rotary selector disposed between the fluid control valve and the actuators to enable the fluid control valve to selectively supply the actuating fluid to the actuators. In some embodiments, the actuator includes an inner member made from an elastic material and having straight walls to define a straight, cylindrically shaped compartment for receiving an actuating fluid, the inner member being moveable in an axial direction from a relaxed state to an expanded state by introducing an actuating fluid into the inner member to pressurize the inner member and an outer member being disposed immediately adjacent to and around the elastic inner member to control expansion of the elastic inner member in a radial direction, the outer member being inelastic in the radial direction and expandable in the axial direction as the inner member moves from the relaxed state to the expanded state, the outer member being formed from a sheet of material such that the outer member forms an uninterrupted barrier such that there are no opening in the outer member in the expanded state to prevent the inner member from protruding through the outer member, wherein the outer member is configured to freely expand or contract in the axial direction along the inner member as the inner member moves between the relaxed state and the expanded state.

In some embodiments, the exoskeleton further includes a one or more ports, each configured to receive at least one of the one or more fluid tubes to establish a continuous fluid flow through the device when a fluid tube is uncompressed. In some embodiments, each of the one or more threads comprises a pair of loops coupled together. In some embodiments, each pair the loops are coupled together using a barrel clasp. In some embodiments, the one or more fluid tubes further comprise outer sheathing to protect the fluid tubes from damage when under tension by the one or more threads. In some embodiments, the support structure further comprises one or more control access points through which the one or more threads extend through to around an exterior surface of one of the one or more fluid tubes. In some embodiments, the one or more threads extend around an exterior surface of the one or more fluid tubes. In some embodiments, the one or more fluid tubes is compressed by the one or more threads when the tensioning element is in a neutral state and at least one of the one or more fluid tubes is uncompressed by at least one of the threads when the tensioning element is rotated about the axis point. In some embodiments, the exoskeleton further includes one or more beads positioned on a surface of the tensioning element, the one or more beads configured to move along the surface of the tensioning element when the force is applied to the tensioning element. In some embodiments each of the one or more threads are connected to one of the one or more beads.

In accordance with the present disclosure, a fluid flow control valve is provided. The valve includes a support structure, a plurality of fluid tubes coupled to the support structure, a rigid element coupled to the support structure, the rigid element being configured to rotate about an axis point, a motorized unit coupled to the support structure and the rigid element, the motorized unit configured to apply a rotational force to the rigid element, a plurality of beads coupled to an upper surface of the rigid element, the plurality of beads configured to move along the upper surface of the rigid element when the rotation force is applied to the rigid element, and a plurality of threads, each extending through a hole in one of the plurality of beads and around an exterior surface of the plurality of fluid tubes, the plurality of threads configured to provide sufficient tension to compress the plurality of fluid tubes against the support structure.

In accordance with the present disclosure, a method for controlling fluid flow through a control valve is provided. The method includes providing a fluid flow control valve. The valve including a plurality of fluid tubes, a tensioning element, a plurality of beads coupled to an upper surface of the tensioning element, and a plurality of threads, each extending through a hole in one of the plurality of beads and around an exterior surface of one of the plurality of fluid tubes, the plurality of threads configured to provide sufficient tension to compress the plurality of fluid tubes against the support structure. The method also includes rotating the tensioning element in one direction to cause one of the plurality beads to move to cause one of the plurality of threads to reduce the tension applied to one of the plurality of fluid tubes. The reduced tension is sufficient to allow fluid to flow through the one of the plurality of fluid tubes.

### BRIEF DESCRIPTION OF THE FIGURES

These and other characteristics of the present disclosure will be more fully understood by reference to the following detailed description in conjunction with the attached drawings, in which:

FIG. 1A is a front view of a flow control valve in accordance with the present disclosure;

FIG. 1B is a side view of a flow control valve in accordance with the present disclosure;

FIG. 2A is an isometric view of a support structure for a flow control valve in accordance with the present disclosure;

FIG. 2B is a front view of a support structure for a flow control valve in accordance with the present disclosure;

FIG. 2C is a side view of a support structure for a flow control valve in accordance with the present disclosure;

FIG. 3A is an isometric view of a curved portion of a flow control valve in accordance with the present disclosure;

FIG. 3B is a front view of a curved portion of a flow control valve in accordance with the present disclosure;

FIG. 3C is a side view of a curved portion of a flow control valve in accordance with the present disclosure;

FIGS. 4A and 4B are example operations of a flow control valve in accordance with the present disclosure;

FIG. 5 is an isometric view of a rigid support and fluid tube for a flow control valve in accordance with the present disclosure;

FIGS. 6A, 6B, 6C, and 6D are example configurations of the thread in accordance with the present disclosure;

FIGS. 7A, 7B, and 7C are example operations of a flow control valve in accordance with the present disclosure;

FIG. 8 is a general valve geometric model used to determine tension of a thread in accordance with the present disclosure;

FIG. 9 is a general case with two centers of radius for each half of rigid rotating element in accordance with the present disclosure;

FIGS. 10A, 10B, and 10C are example operations of a flow control valve in accordance with the present disclosure;

FIG. 11 is an example system implementing a flow control valve in accordance with the present disclosure;

FIG. 12 is an example system implementing a flow control valve in accordance with the present disclosure;

FIG. 13A is an example a lattice device including an actuator according to the present disclosure;

FIG. 13B and FIG. 13C are examples of use of a lattice device according to present disclosure;

FIG. 13D is an example of an exoskeleton joint utilizing a lattice device according to the present disclosure;

FIG. 13E and FIG. 13F are examples of use of a lattice device according to present disclosure;

FIG. 14A and FIG. 14B are examples of use of a stiffness device according to present disclosure; and

FIG. 14C is an example of an exoskeleton utilizing stiffness devices according to the present disclosure.

### DETAILED DESCRIPTION

An illustrative embodiment of the present disclosure relates to a valve providing controllable fluid flow between a plurality of ports. The valve of the present disclosure can be designed and manufactured in a compact scale to be used in conjunction with a combination of electrical and mechanical systems. The disclosed valve provides a simple to operate flow control mechanism, with the ability to manipulate liquid and gas through at least an entry and export port. In some embodiments, the valve can include a motor and tube casing coupled with a curved element. The motor, tube casing, and curved element can be used in combination with two spherical cam followers (beads), the servo motor, and at least two tubes serving as the flow channels, which allow for bi-directional fluid flow. The motor can cause a rotation of the curved element to cause the beads to tension or release tension on one or more treads to cause a “choking” or “opening” operation on one or more fluid lines (e.g., tubing).

In a neutral position for the control valve, a symmetrically positioned motorized unit may not by applying any torque force to the curved element, which in turn keeps all ports closed. In some embodiments, a motorized unit can be utilized to control the flow through the various ports by moving the curved element. To open one of the ports, the motorized unit can apply torque to the curved element in different directions to open different channels. For example, when the curved element is rotated in one direction, a channel located in the opposing direction from the rotation will be opened. The control value of the present disclosure can be applied to, but it is not limited to, wearable assistive and augmenting technologies, robotics, aerospace, medical devices, pneumatic and hydraulic machines, etc.

To provide the opening and closing, the present disclosure can make use of a thin cord (or thread) looped around rubber (typically latex) tube. In some embodiments, the thread can apply force only to a small tube area, and hence fluid resistive force is small even for large fluid pressures. The rotation of the curved element can cause pilling or slacking of the thread, and hence an increase or decrease of tension applied by the cord looped around the tube. This change in tension can affect compression of the tube, resulting in opening or closing tube, thus controlling fluid flow through the tubes. Therefore, a small, lightweight, and cost-effective motor is only needed to actuate the tube to provide fine fluid control. Using this configuration, the valve of the present disclosure can be a cost effective, energy efficient valve, that requires only a small amount of force to operate. The valve of the present disclosure (although primarily designed for fluids, i.e. various gasses and liquids) can be also used on solids such as granules, powders, pellets, chippings, fibers, slivers, any kind of slurries and aggressive products.

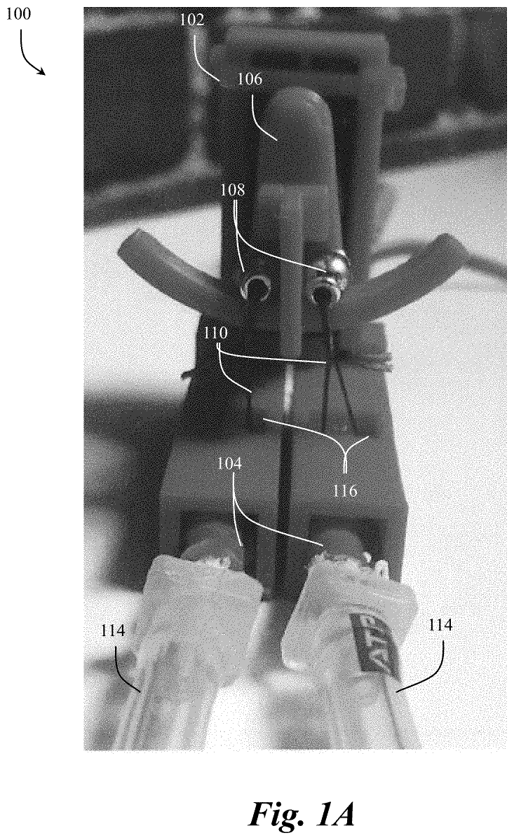

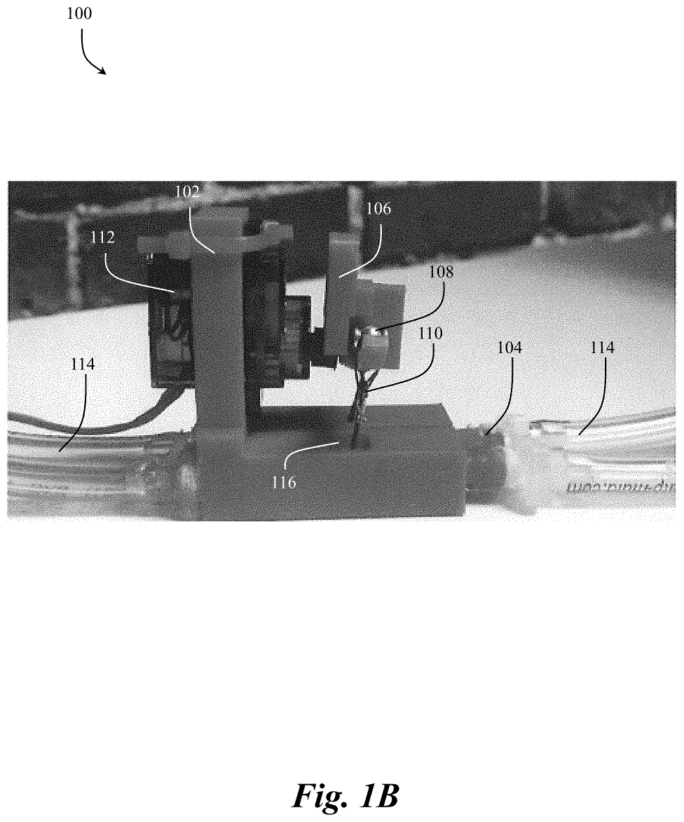

FIGS. 1A through 13D, wherein like parts are designated by like reference numerals throughout, illustrate an example embodiment or embodiments of improved design and operation for a fluid control valve, according to the present disclosure. Although the present disclosure will be described with reference to the example embodiment or embodiments illustrated in the figures, it should be understood that many alternative forms can embody the present disclosure. One of skill in the art will additionally appreciate different ways to alter the parameters of the embodiment(s) disclosed, such as the size, shape, or type of elements or materials, in a manner still in keeping with the spirit and scope of the present disclosure.

Referring to FIG. 1A, a front view of an example fluid control valve 100 system is depicted. Referring to FIG. 1B, a side view of an example fluid control valve 100 is depicted. In some embodiments, the fluid control valve 100 can include a support structure 102, ports 104, tensioning element 106, beads 108, threads 110, and a motorized unit 112. The support structure 102 is configured to house and couple the various elements of the fluid control valve 100 together. In some embodiments, each of the ports 104 can be configured to receive fluid tubes 114. Any combination of shapes can be used for the structure 102, ports 104, and tensioning element 106 without departing from the scope of the present disclosure as long as they provide the functionality discussed herein.

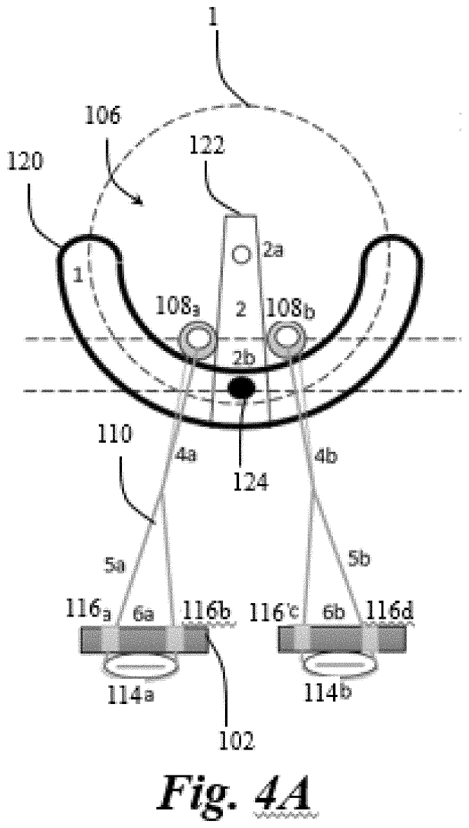

In some embodiments, the open flow through the tubes 114 can be partially controlled by a plurality of small beads 108 positioned on the tensioning element 106. The beads 108 can be configured with threads 110 that pass through central openings within the beads 108, through openings within the structure 102 itself, and wrapped around the lower portion of the tubes 114 to inflict an upward force on the tubes 114 when held under tension. Rotating the tensioning element 106 to reposition the beads 108 can modify the tension on the tubes 114 to open or close the ports 104. In some embodiments, the change in tension can be enabled by rolling the beads 108 that are positioned on opposing sides of the tensioning element 106 by rotating the tensioning element 106. Rotation of tensioning element 106 from a neutral state in either direction can cause at least one of the beads 108 to roll, which can cause a reduction of tension applied by the thread 110 on one end, extending through that bead 108, on an elastic tube 114 to reduce the upward application of force on the tube 114, thus allowing the tube 114 to open. In other words, as the tensioning element 106 is rotated, one of the beads 108 will be held in the same or greater tension as in the initial neutral state (in which all ports 104 are closed) while at least one bead 108 will roll to a position of lesser tension than the neutral state, as discussed in greater detail with respect to FIGS. 4A and 4B.

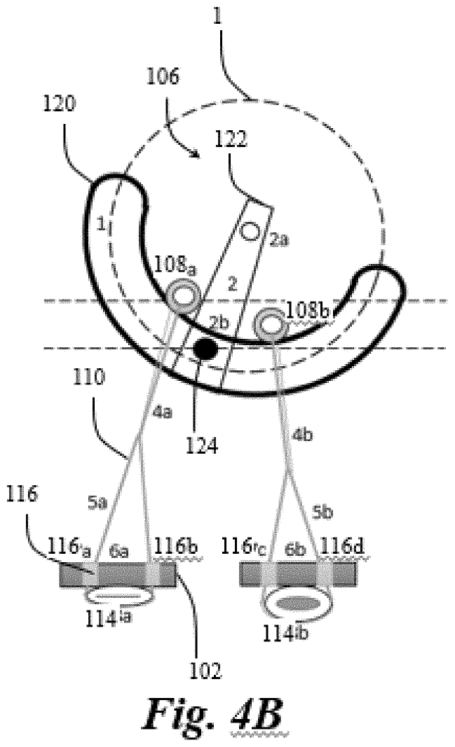

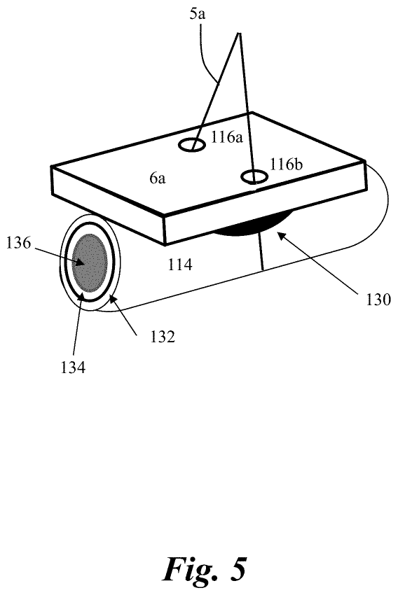

In some embodiments, the tube 114 can be covered with inelastic element that prohibit ballooning of the rubber tube and also provide protective layer such that a thread 110 does not cut through tube 114 while applying tension. In some embodiments, the tube 114 can be on one side also pressed against slightly curved rigid wall on the outside of the tube 114, as discussed in greater detail with respect to FIG. 5. It has been experimentally determined this curved extension stipulate closing of the tube 114 with less external tension force applied by the thread 110. The unique design and function of the flow control valve 100 of the present disclosure results in a small compact, lightweight, low-cost advanced fluid flow control valve.

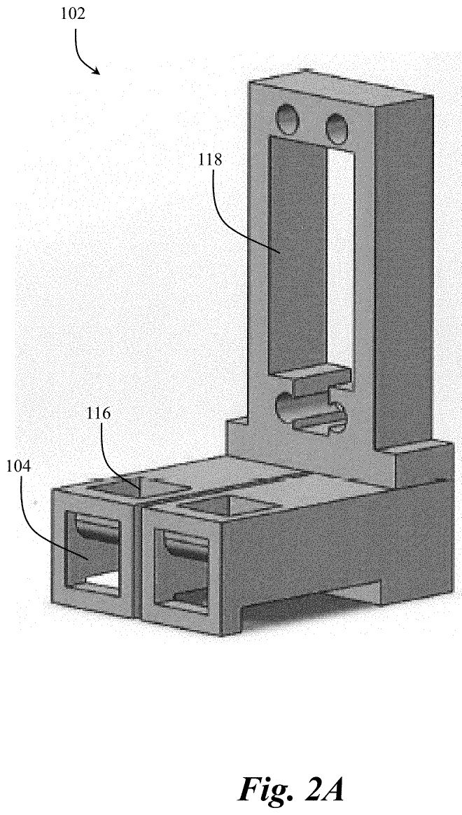

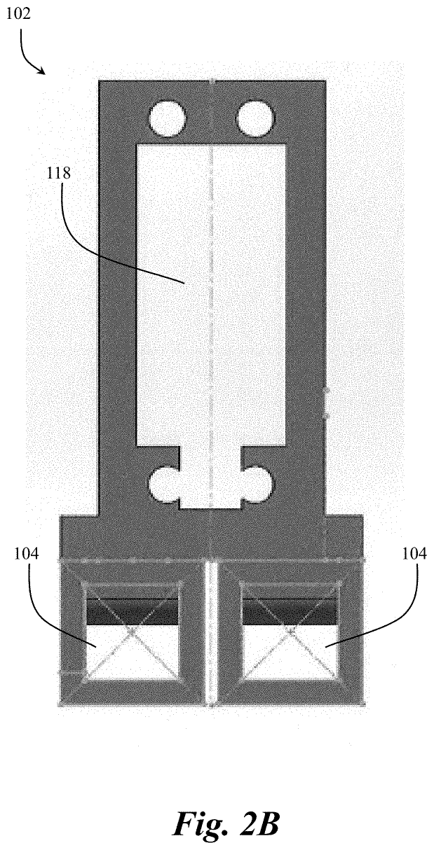

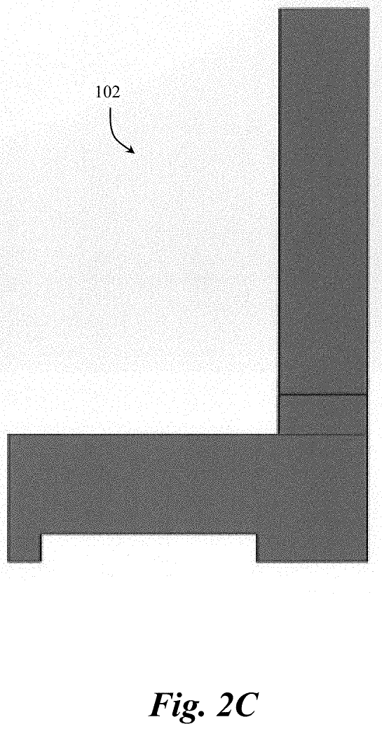

Referring to FIGS. 2A, 2B, and 2C, isometric, front, and side views of an example support structure 102 for the fluid control valve 100 are depicted. FIGS. 2A, 2B, and 2C show the support structure 102 including a plurality of ports 104 for accepting fluid tubes 114, one or more control access points 116, and mounting points 118 for one or more motorized units 112. In some embodiments, the structure 102 includes a substantially vertical portion for mounting the one or more motorized units 112 and/or the tensioning element 106 and a substantially horizontal portion to couple with fluid inputs/outputs to create a continuous fluid flow through the structure 102. The ports can be configured to couple to fluid conduits (e.g., tubes) on each end of the structure 102 or they can house the fluid conduits extended through the structure 102 inserted through a first end and out the opposing end. Regardless of design, the ports provide a continuous flow path between an input flow and an output flow of the structure 102 itself. The substantially horizontal portion can also include access points 116 in which controls (e.g., thread 110) can be inserted to control an amount of flow allowed through the fluid channels (e.g., tubes 114) running through the ports 104. The combination of the a substantially vertical portion and a substantially horizontal portion can create an ‘L’ shape. Although the “L” shape structure is provided in FIGS. 1A-2C, any combination of shapes can be used without departing from the scope of the present disclosure.

The fluid control valve 100 can include any number of ports 104 that are designed to transport fluid from a first side of the fluid control valve 100 to another side of the fluid control valve 100. For example, as depicted in FIGS. 2A-2C, the fluid control valve 100 can include two pairs of ports on opposing sides of the fluid control valve 100. Although the ports 104 are square in FIGS. 2A-2C, any combination of shapes can be used such that they receive tubes 114 and allow the flow of fluid therethrough. For example, the ports 104 can be rectangular, circular, polygonal shaped, etc. The plurality of ports 104 for accepting fluid tubes 114 can be used to create fluid channels that can be controlled via the control access points 116, as discussed in greater detail herein.

In some embodiments, the fluid tubes 114 can be closed by compressing the fluid tubes 114 against the support structure 102 itself, as discussed in greater detail below. For example, threads 110 can be used for compressing tubes 114 against a top portion of the ports 104, as shown in FIGS. 4A and 4B. In some embodiments, the fluid tubes 114 can be coupled to an open channel within the support structure 102 and the threads 110 can be coupled to pull, a flap, or other mechanism within the support structure 102 to close the open channel instead of compressing fluid tubes 114, effectively closing the channel. Any combination of mechanisms for closing a port 104 in response to rotation of the tensioning element 106 can be used without departing from the scope of the present disclosure.

Continuing with FIGS. 2A, 2B, and 2C, in some embodiments, the support structure 102 can provide mounting points 118 for one or more motorized units 112 designed to provide a rotational force. For example, the one or more motorized units motorized units 112 can provide the force necessary to move the tensioning element 106 in accordance with the present disclosure, discussed in greater detail herein. The one or more motorized units motorized units 112 can include any combination of motors capable of providing rotational force to the tensioning element 106 in accordance with the present disclosure. For example, the one or more motorized units 112 can be a 0.215 Nm, 0.08 sec/60 degree @6V servo motor (MG90D High Torque Metal Gear), which allows the valve 100 to quickly and robustly handle over 0.69 MPa (100 PSI) of pressure.

In some embodiments, the valve 100 can be designed to operate in three different states. A neutral state in which flow through each of the ports 104 is closed, an inflow state in which flow is permitted through one of the three ports, and an outflow state in which flow is permitted through another of the three ports. For example, in a three-port design, a neutral state will have all ports 104 closed (i.e., ports A, B, and C), an inflow state will have two of the ports open (i.e., ports A and B) with the third port closed (i.e., port C), and an outflow state will have a different combination of ports open (i.e., ports B and C) with the third port closed (i.e., port A). By providing rotation to the tensioning element 106, the one or more motorized units 112 can assist in controlling the open and closed states of the ports 104 for each of the states via the combination of the tensioning element 106, beads 108, and threads 110.

The support structure 102 can be designed to include mounting points for any number of motorized units 112, ports 104, fluid tubes 114, and tensioning elements 106. For example, a support structure 102 can include a single motorized unit 112, three ports (i.e., ports A, B, C) and two control access points 116 for controlling fluid flow through the three ports. In some embodiments, two motorized units 112 can be used to operate two tensioning elements 106 to control pairs of ports 104 on opposing sides of the structure 102.

In some embodiments, the support structure 102 can be configured to support and/or be coupled to the tensioning element 106 and allow rotation of the tensioning element about a pivot point on the support structure 102. The pivot point can be the point in which the tensioning element 106 is rotated about, for example, the point in which the tensioning element 106 is attached to the motorized unit 112. The tensioning element 106 can also be indirectly attached to the support structure 102. For example, the tensioning element 106 can be coupled to the motorized unit 112 which would be coupled to the support structure 102 via the mounting points 118.

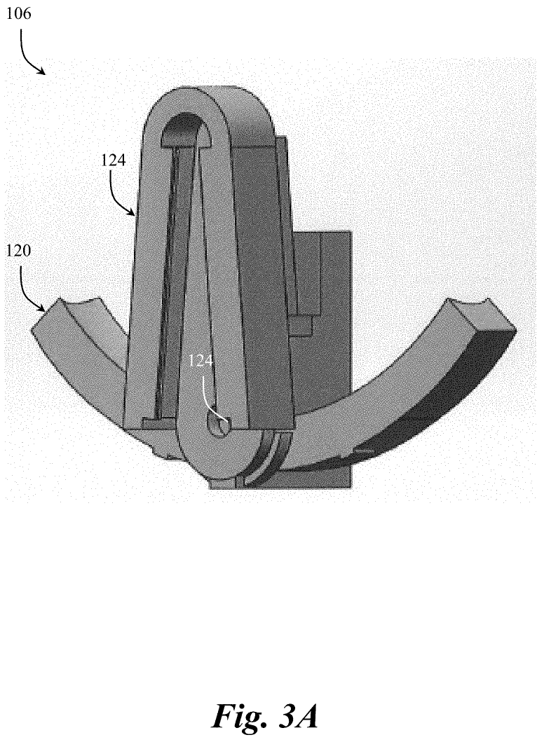

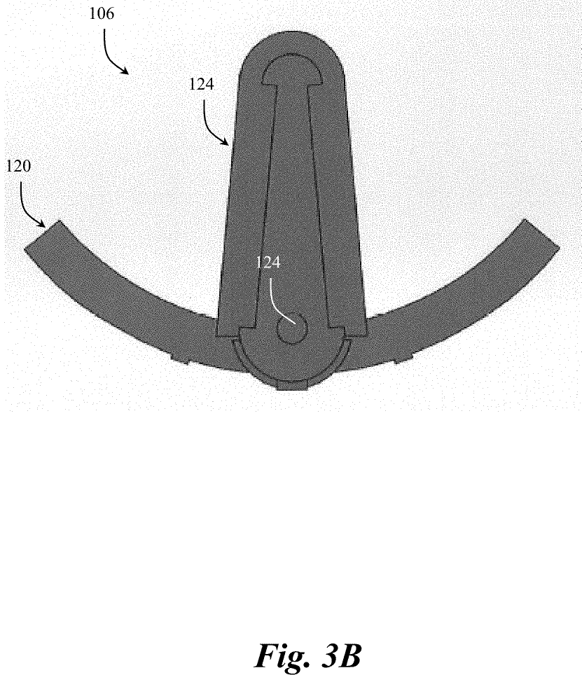

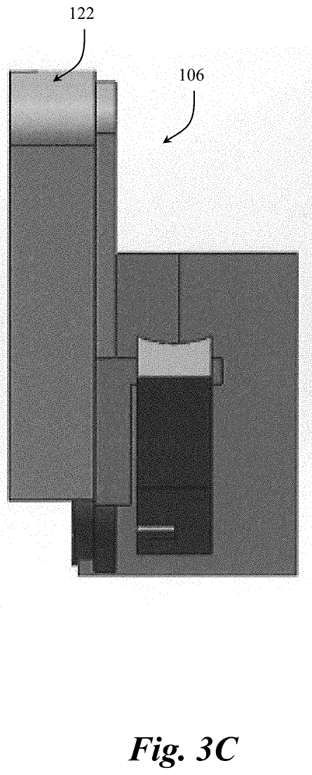

Referring to FIGS. 3A-3C, isometric, front, and side views of an example tensioning element 106 are depicted. In some embodiments, the tensioning element 106 can be any shape that can be rotated along a circular or pendulum shaped pathway. As depicted in FIGS. 3A-3C, the tensioning element 106 can be an anchor shape with a curved portion 120 and a vertical center portion 122 located centrally within and extending perpendicularly from the curved portion 120 to a center axis. Although an anchor shape is provided as an example, any combination of shapes can be used for the tensioning element 106 that enables modifying tension being applied to threads 110 to control openings at ports 104. For example, the tensioning element 106 can be a horizontal shape that moves in a horizontal direction (parallel to the horizontal portion of the structure 102) to tension and un-tension threads 110 directly or indirectly coupled thereto.

In some embodiments, the curved tensioning element can be modelled after a circle with a center of the circle at a center axis point 2a, as depicted in FIGS. 4A and 4B. The vertical center portion 122 can be configured to be coupled to the support structure 102 and/or the motorized unit 112 at a pivot point 124 to facilitate rotation of the curved portion about the pivot point 124. The vertical center portion 122 can be any shape to be mounted to the support structure 102, receive torque from a motorized unit 112, and enable the rotation of the curved portion 120, in accordance with aspects of the present disclosure. For example, the vertical center portion 122 can be a trapezoidal shape. In some embodiments, the tensioning element 106 can be configured to balance beads 108 located on each side of a vertical center portion 122 and allow the beads 108 freedom of movement on top of the curved portion 120 tensioning element 106, as discussed in greater detail with respect to FIGS. 4A and 4B. The beads 108 can be placed on low friction tracks to allow them to move smoothly on the curved portion as the tensioning element 106 rotates.

In some embodiments, in place of the beads 108, the tensioning element 106 can have one or more threads 110 directly wrapped around a curved portion in place of the beads 108. The tensioning element 106 can include any combination of size, shape, and materials to allow rotation by a motorized unit 112 to change tautness on one or more threads 110 directly or indirectly (e.g., via beads 108) coupled to the tensioning element 106.

Referring to FIGS. 4A and 4B, an example configuration and operation of the tensioning element 106 is depicted. FIGS. 4A and 4B depict a front view of the valve 100 in two operational states. In some embodiments, the fluid control valve 100 can include one or more threads 110 coupled to and/or looped through one or more beads 108 positioned on the tensioning element 106. The threads 110 can include any combination of materials capable of providing sufficient tension to compress the fluid lines 114 and reduce tension on the fluid lines 114 at the access points 116 of the ports 104 when the tensioning element 106 is rotated. For example, the threads 110 can be a combination of string, nylon, metal cabling, etc. The threads 110 can be configured in any manner in which they are able wrap around a bottom portion of the tubes 110 (or other compressible object) and to move about the tensioning element 106 to adjust tension applied to the tubes (or other compressible object). In some embodiments, a protective layer can be wrapped around the tubes 114 to protect the tubes 114, beads 108, and any other components from being damaged by the threads 110 during operation (e.g., friction, tension, etc.). For example, the tubes 114 can be 5 mm wide, 1 mm thick surgical tubing encased in kite fabric, which prevents ballooning and the possible bursting of the tubes 114, as well as adding additional protection against friction from the threads 110.

FIG. 4A depicts the tensioning element 106 in an initial or neutral state, with the tensioning element 106 in a centered resting position with the vertical center portion 122 substantially vertical. In some embodiments, when in the neutral position no force is imparted on the tensioning element 106 by the motorized unit 112 and the threads 110 are both held in tension between the beads 108 and the fluid tubes 114, for example, through the control access points 116 of the support structure. In some embodiments, when in a neutral state, the threads 110 are held in sufficient tension to compress the tubes 114 to a closed position in which no fluid can flow therethrough. As tension is released on the threads 110, the tubes 114 will eventually reform back to a naturally open state (a state in which there is no force applied to the tubes 114 by the tensioned threads 110).

In some embodiments, each of the threads 110 can include two loops 4, 5 coupled together, as shown in FIGS. 4A and 4B. The two loops can include proximal cord loops 4a and 4b that can be coupled together to distal cord loops 5a and 5b to form the overall threads 110. In some embodiments, employing two interconnected string loops 4a, 4b, 5a, 5b, etc. may provide added stability to the bead, for example, prevent rotation of the bead. Each of the proximal cord loops 4a, 4b can pass through a respective bead 108 and through one distal cord loop 5a, 5b. Each of the distal cord loops 5a and 5b can looped through the control access points 116 and around the respective fluid tubes 114a and 114b to compress the fluid tubes 114a and 114b against rigid supports 6a and 6b of the support structure 102, respectively. When the fluid tubes 114a and 114b are fully compressed against the rigid supports 6a and 6b, the fluid is not able to pass through the fluid tubes 114a and 114b, effectively closing that channel, as shown in FIG. 4A.

In operation, the curved portion 120 of the tensioning element 106 can be rotated along a circular pathway 1 in response to a rotational force applied by the motorized member 112 at the center axis point 2a. The pathway 1 creates a circular pathway, as depicted in FIGS. 4A-4B, that the curved portion 120 can travel along in either a clockwise direction or counter-clockwise direction. The rotation contributes to control the flow of fluid through respective channels. In some embodiments, the vertical center portion 122 of the tensioning element 106 can assist in maintaining a thread 110 in tension. For example, as the tensioning element 106 rotates, the vertical center portion 122 can push any beads 108 positioned on the curved portion 120 in the direction of the rotation, as shown in FIG. 4B and discussed in greater detail below.

Starting in the neutral state, as depicted in FIG. 4A, both beads 108a, 108b are holding the threads 110 under sufficient tension to compress the tubes 114 in a closed position. A clockwise rotation of the tensioning element 106 connected to vertical center portion 122 about the pivot point 124 causes the curved portion 120 to rotate and the beads 108a and 108b resting thereon will move accordingly. Specifically, bead 108a will be pushed by the center portion 122 causing an increased tension on the tube 114a. At substantially the same time, the bead 108b will roll away from the vertical center portion 122 to a lower position than that of the starting neutral position, causing the tension in the thread 110 to lessen on the tube 114b to a partially open state, as depicted in FIG. 4B. As rotation continues, the application of force on tube 114b because the relative distance between bead 108b and tube 114b decreases, causing the opening of the fluid tube 114b. At the same time, the tension at bead 108a remains the same or increases as it is pushed by vertical center portion 122, such that the fluid tube 114a remains compressed/closed.

Similarly, a counterclockwise rotation (not depicted) of the curved portion 120 about the pivot point 124 (from the neutral state depicted in FIG. 4A) would cause the bead 108a roll in the opposite direction as depicted in FIG. 4B while bead 108b is pushed in the same direction as the rotation. In this instance, as the tension is lessened at bead 108a, the relative distance between bead 108a and fluid tube 114a would then decrease, causing the opening of fluid tube 114a, while fluid tube 114b compress toward a closed state.

The control valve 100 can be configured to open/close the fluid tubes 114 any percentage between 0% and 100%. The percentage of opening can be directly controlled by the angle of rotation of curved portion 120 connected to vertical center portion 122 about axis of rotation 2b. The different amounts of rotation will result in a different modification of tension on the beads 108, thus resulting in a different percentage of opening for the tubes 114. This functionality allows for precise control of fluid flow through the channels of the control valve 100, enabling intermittent, analog stages of operation and flow. Implementing the utilization of the beads 108 to control the fluid control provides a device that significantly reduces frictional loss and power consumption. The forces can be minimized by the small diameter of distal cord loops 5a and 5b because the tension in proximal cord loops 4a and 4b is minimized and the torque on the curved portion 120 is also minimized. As a result, the motorized unit 112 does not need to apply a very large torque in to transition the curved portion 120 between states, and the system is very energy efficient. In the neutral state, minimal motor active torque is needed, as torques due to tensions from the two proximal cord loops 4a, 4b almost exactly cancel each other.

Referring to FIG. 5, an isolated isometric view of an example rigid support 6a and a fluid tube 114, for example as provided in FIGS. 4A and 4B, is depicted. In some embodiments, the rigid support 6a can be added to the support structure 102 with a small curved rigid extension 130 that supports a more natural bending of the fluid tube 114 when compressed by the distal cord loop 5a and less tension is needed with the curved rigid extension 130 in place. In some embodiments, portions of fluid tube 114 that are a part of the flow control valve 100 can include an outer sheathing 132 and latex tube 134 that contains fluid 136. The outer sheathing 132 can restrict ballooning of the latex tube 134. The fluid tube 114 can be connected to an appropriate connecting component (not depicted), that then leads to any standard (rigid, semi-rigid, or elastic) fluid tube outside of the flow control valve 100.

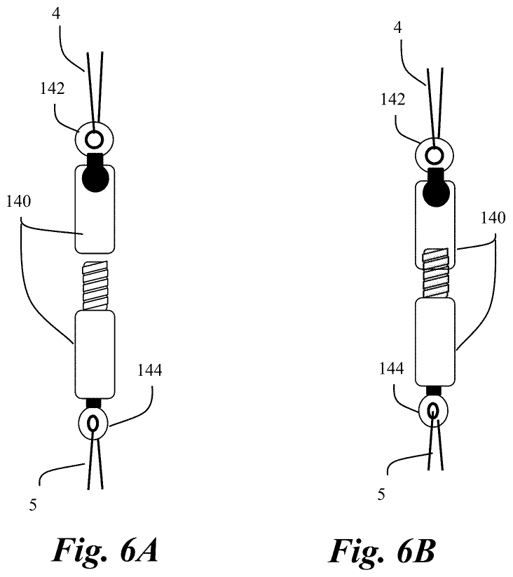

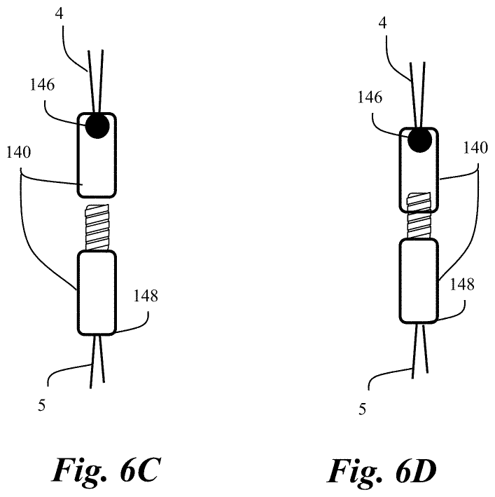

Referring to FIGS. 6A-6D, example embodiments of a connection point between thread 110 loops 4, 5 are depicted. In some embodiments, to provide fine-tuning of the proper length of two threads 110 can be adjusted by adjusting the loops 4, 5, that make up the threads 110. Even small inaccuracy in thread 110 lengths can potentially change valve specifications drastically or even result in an inability of valve 100 to fully close one or more of the channels within the tubes 114 in its neutral position or in a rotated state. The preferred length of the threads 110 provides simultaneous closure of both fluid channels when the valve 100 is in a neutral position, as shown in FIG. 4A.

In some embodiments, adjustable barrel clasps 140 can be used to fasten together two loops 4, 5, to form a thread 110. The barrel clasps 140 can include two tensioning elements configured to be screwed onto each other, as shown in FIGS. 6A-6D. The barrel clasps 140 can be combined using male and female pairs such that the male includes a threaded section sized and dimensioned to screw into a threaded recess within the female portion. FIGS. 6A and 6C depict the barrel clasps 140 prior to coupling, for example, by screwing male and female portions together. Similarly, FIGS. 6B and 6D depict barrel clasps 140 after they have at least partially been coupled together to form a single adjustable thread 110 structure. The barrel clasps 140 can be screwed into one another a specific amount and then fixedly attached in that position, for example, by an application of an adhesive or welding material. As such, the barrel clasps 140 can be finely tuned during the manufacturing process such that both channels are closed off in the neutral state. Similarly, the barrel clasps 140 can be removably attached such that they can be readjusted over time, for example, if the thread stretched over time. In some embodiments, the loops 4, 5 of the threads 110 can pass through small loops or hooks on each side of the barrel clasp 140 or alternatively small knot may be created and placed on inside of barrel clasp 140, as shown in FIGS. 6A-6D.

Referring to FIGS. 6A-6B, in some embodiments, the barrel clasps 140 can include eye hooks 142, 144 for receiving the loops 4, 5, respectively. The eye hooks 142, 144 can be sized and dimensioned to receive the loops 4, 5 and can be coupled to the barrel clasps 140 using any combination of mechanisms. For example, the eye hooks 142, 144 can be coupled by a ball joint or similar mechanism that allows them to freely rotate in at least one dimension at the ends of the barrel clasp 140 it is attached. Having the eye hooks 142, 144 attached at the ends of the barrel clasps 140 enables the loops 4, 5 to move freely as the tensioning element 106 moves while also maintaining a consistent orientation in relation to the barrel clasps 140.

Referring to FIGS. 6C-6D, in some embodiments, the barrel clasps 140 can include fastener mechanisms 146, 148 for tying the loops 4, 5 to the barrel clasps 140, for example, in knots. The fastener mechanisms 146, 148 can be sized and dimensioned to allow the loops 4, 5 to be tied thereto. The fastener mechanisms 146, 148 can be located externally on the barrel clasp 140, such as fastener mechanism 146 or internally within the barrel clasp 140, such as fastener mechanism 148. Having the fastener mechanisms 146, 148 located at the ends of the barrel clasps 140 enables the loops 4, 5 to move freely as the tensioning element 106 moves while also maintaining a consistent orientation in relation to the barrel clasps 140. Any combination of mechanisms to couple loops 4, 5 together can be used without departing from the scope of the present disclosure.

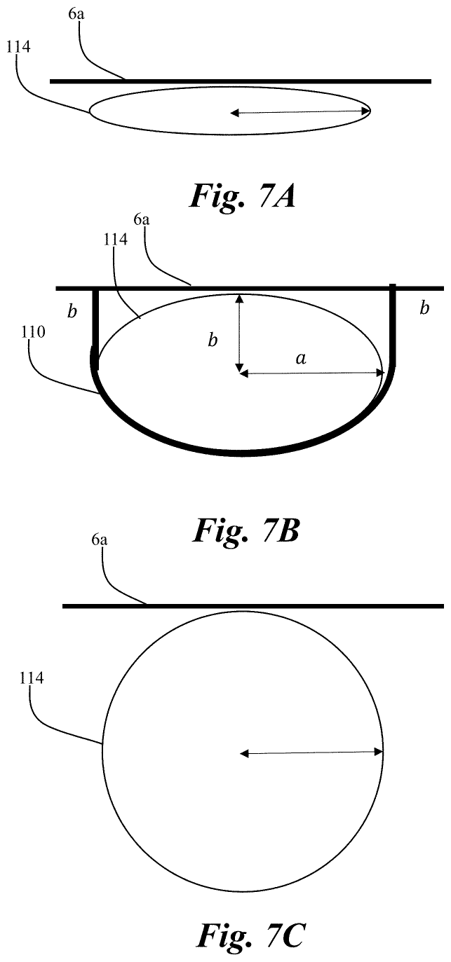

Referring to FIGS. 7A-7C, an isolated cross-sectional view of a rigid support 6a and a fluid tube 114, for example as provided in FIGS. 4A and 4B, is depicted. The curved element rotation causes one bead to move away from the valve symmetry axis and decrease distance to small anchor openings in the base just next to the opening tube. This change in length is directly related to amount that tube opens.

The geometric values in FIGS. 7A-7C can be used to calculate the necessary movement of the thread 110 to allow a tube to fully open, the strain on the string on a side that is already closed, and the desired dead-band angle for valve operation. As discussed herein and as depicted in FIG. 4B, as rotation of the tensioning element 106 causes one bead 108 to roll away from the symmetry axis of the tensioning element 106, the distance between the bead 108 and the anchor position of the thread 110 above the tube is reduced to allow the tube 114 on that side of the valve to open. The total change in length needed for tube to fully open can be obtained from an elliptical model. Specifically, the total change in length (Δl) between a bead and corresponding thread, needed for the tube 114 to transition from fully closed (FIG. 7A) to fully open (FIG. 7C), can be obtained from the elliptical model:

$$Δ l \approx {\{ 2 b + \frac{π}{2} [ 3 ( a + b ) - \sqrt{( 3 a + b ) ( a + 3 b )} ] \}}_{b = 0}^{b = a} \qquad ( 1 )$$

With a being the inner radius of the pressurized tube 114 and also a length of the ellipse's semi-major axis with b being a vertical radius of the tube 114 and also length of the ellipse's semi-minor axis at any point of compression.

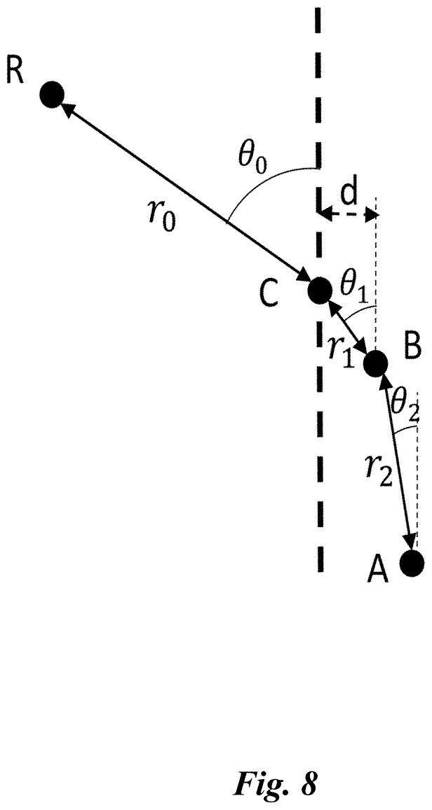

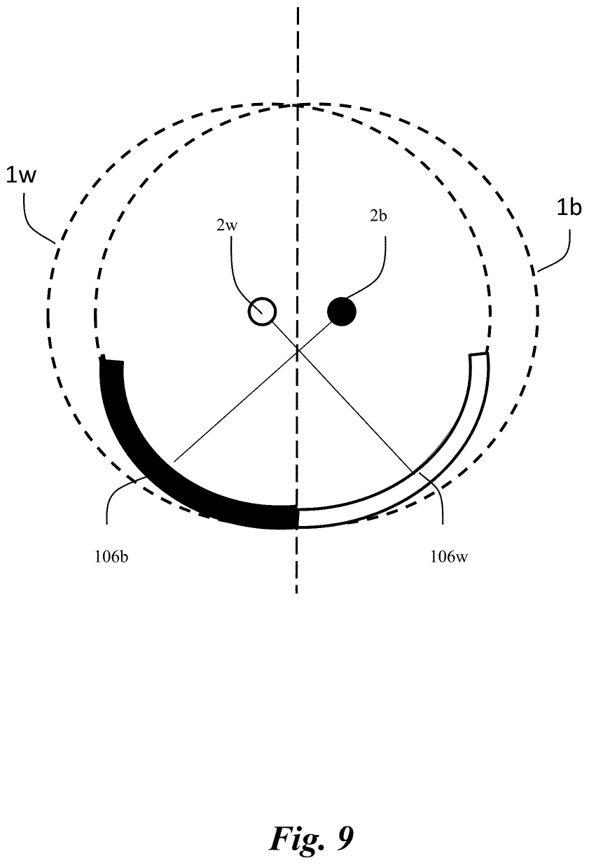

Referring to FIG. 8, in some embodiments, a general valve geometric model can be used to relate thread 110 slackening, for a tube 114 that is opening, thread 110 strain for a tube 114 that is closed, and the angle of rotation for a set of specified valve parameters. FIG. 8 depicts a general valve geometric model in which: A=anchor point (e.g., next to tube), B=bead string contact point, C=center of rotation, R=center axis point for only half of the curved tensioning element (i.e. there could be two R's as depicted in FIG. 9 which can also coincide), (e.g., 2a of FIGS. 4A and 4B), r0=RC distance, r1=CB distance, r2=BA distance, and 00, 01, 02=angles between vertical and r0, r1, r2. This general configuration includes two separate, symmetric, curvature radii, of which only one R is shown in, and a dead band angle, which prevents the bead from rolling until points R, B, and A are collinear. The parameters of the geometric model can be optimized such that: (1) the valve 100 volume is minimized and dimensions are scaled to the appropriate operation conditions, (2) the slackening for the fully open condition is attained within a rotation range (e.g., approximately 50°), (3) the amount of strain on the closed side is minimized (e.g., approximately 1 mm), (4) the dead band is sufficient to account for rotation related positioning errors, to prevent undesirable flow, while not being so large as to substantially affect simple control (e.g., approximately 51, (5) the motorized unit 112 can have sufficient torque as to easily close the tube 114 for the desired operational pressure (e.g., approximately 100 PSI fluid pressure).

The optimized geometric configuration has coinciding R's positioned on the valve symmetry axis (i.e. θ₀=0°, AB axis (r₂)) parallel to the symmetry axis with θ₁=135°, θ₂=0°. The values for r₀, r₁, r₂ are dependent on the dimension of the tube 114, overall valve, and moment that motorized unit 112 can produce. Based on results provided by the geometric model, the valve 100 of the present disclosure can have a curvature radius of approximately 20 mm and a total operational angle span of approximately 42 degrees that can be used to finely control flow through the tubes 114. Using dimensions of approximately 6 cm×5 cm×2 cm, the valve 100 will only occupy ⅔ of that volume due to its L-like shape, and it has a total mass of only approximately 28 grams. This geometric model can be scaled such that the optimization procedure can be easily reproduced with different tube diameters, fluid pressures, and desired valve dimensions for given servo.

Referring to FIG. 9, in some embodiments, the curved tensioning element 106 can have a more complex shape and it can be represented by two jointed arcs, 106b and 106w, with each arc having its own center axis point, 2b and 2w, with two radii that can be equal, as depicted in FIG. 9, or different. In some embodiments, the structure 102 can be configured to accept more than one tensioning element 106 to be used to control one or more ports 104. As shown in FIG. 9, the valve 100 can include a first tensioning element 106b and a second tensioning element 106w positioned adjacent to one another with different center points of access 2b, 2w. In FIG. 9, there is a representation of the first tensioning element 106b with a first center point 2b and a second tensioning element 106w with a second center point 2w. Because each tensioning element 106b, 106w has a different center point 2b, 2w, they may have different rotational paths which would be arcs that fall within the circles 1b, 1w. Although two side by side tensioning elements 106b, 106w are depicted in FIG. 9, any combination of tensioning elements 106 in any combination of orientations can be used. For example, instead of having two tensioning elements 106 positioned side by side, there can be a first tensioning element 106 on a front portion of the structure 102 to control two ports 104 and a second tensioning element 106 on a rear portion of the structure 102 to control two other ports 104 (not depicted).

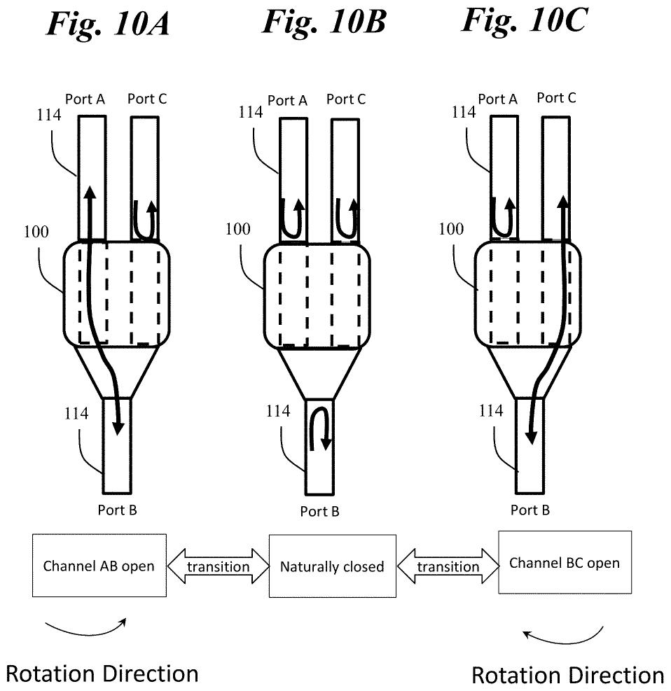

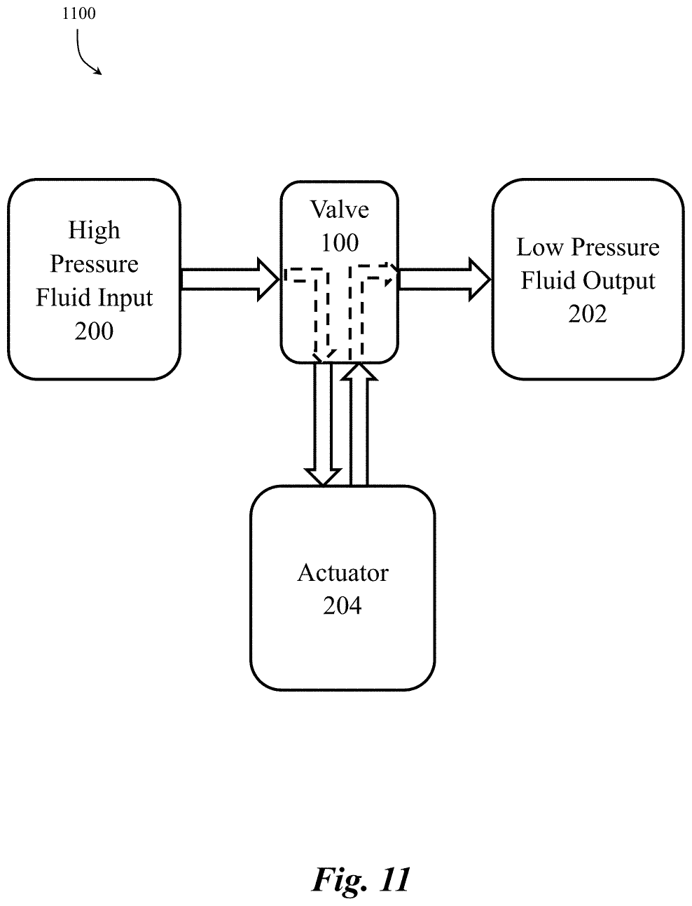

Referring to FIGS. 10A-10C, example illustrative top views representing of the different states of a three-port flow control valve 100 are depicted. The arrows in FIGS. 10A-10C represent the potential fluid flows that can occur when the valve 100 is in the respective states. FIG. 10A depicts a state in which port C is closed and ports A and B are opened, allowing a fluid flow through the open channel between ports A and B. This state can occur when the curved portion 120 is rotated in the counter-clockwise direction (rotated away from the port A), causing a decrease in tension of the thread 110 at the bead 108 proximate to the open fluid tube 114 at port A.

FIG. 10B depicts a state in which ports A, B, and C are closed, allowing no fluid flow through any channel. This state can occur when the curved portion 120 is not acted upon and rests in the neutral position because both fluid tubes 114 are sufficiently compressed by the corresponding threads 110 to stop fluid flow through those tubes 114, as depicted in FIG. 4A.

FIG. 10C depicts a state in which port A is closed and ports C and B are opened, allowing a fluid flow through the open channel between ports C and B. This state can occur when the curved portion 120 is rotated in the clockwise direction (rotated toward from the port A), causing a decrease in tension of the thread 110 at the bead 108 proximate to the open fluid tube 114 at port C. Once one of the ports A or B is open, the valve 100 can be designed such that the fluid flow can occur in either direction. For example, when port A is open (FIG. 10A) the fluid can be flowing from A to B or flowing from B to A.

In some embodiments, the valve 100 can be a three-port valve that controls a flow of fluid or gas between the three ports 104 combining for an inflow and an outflow. One side of the valve 100 can include one port 104 with the opposing side including two ports 104, each connected to separate tubes 114. In some embodiments, one of the tubes 114 can be connected to a pressurizing device while the other tube can be connected to a low-pressure unit such that each connected tube 114 can provide a channel through the structure 102 for either fluid input or output through the valve 100. In the three-port design, when one of the two input or output tubes 114 is opened, they allow fluid to flow in a desired direction through a shared single port 104 on the opposing side of the structure 102. For example, the ports 104 can include port A, port B, and port C with ports A and B combining to provide an inflow pathway and ports C and B combining to provide an outflow pathway. The valve 100 of the present disclosure can also be designed to include any number of ports, for example, the valve 100 can be designed to have a 4-port design with two dedicated input ports 104 and two dedicated output ports 104.

In some embodiments, a three-port fluid control valve 100 can include three main states, including a neutral state that disables flow through all ports 104, a state that enables flow through ports A and B, and a state that enables flow through ports C and B. In its neutral position all ports 104 can be closed stopping a flow through ports A, B, and C. The control valve 100 can also open port A for flow through A and B while having port C closed or it can open port C for flow through C and B while having port A closed. This functionality is discussed in greater detail with respect to FIGS. 10A-10C.

Referring to FIG. 11 a diagram illustrating an example system 1100 for using the valve 100 discussed with respect to FIGS. 1A-10C is depicted. In some embodiments, the system 1100 can include the valve 100 coupled to a high-pressure fluid input 200 and a low-pressure fluid output 202. The input 200 and the output 202 can include any combination of mechanisms capable of providing and withdrawing fluid from the valve 100. The valve 100 can be coupled to the input 200 and output 202 using any competition of mechanisms, for example a tube 114. The input 200 and out 202 can be coupled to the valve 100 at separate ports 104 or the same port 104 with a flow control at another location. In some embodiments, two ports 104 on a rear portion of the structure 102 can be coupled to the respective input 200 and output 202. In some embodiments, the system 110 can include an actuator 204 or other mechanical device that is designed to receive and/or output a fluid flow. The valve 100 can be coupled to one or more actuators 204, for example via tubes 114, to control actuation of the actuators 204. For example, the valve 100 can receive signal inputs to open and close ports 104 in a manner to provide fluid to and from the actuator 204 causing the actuator 204 to inflating and/or deflating in accordance with an intended use.

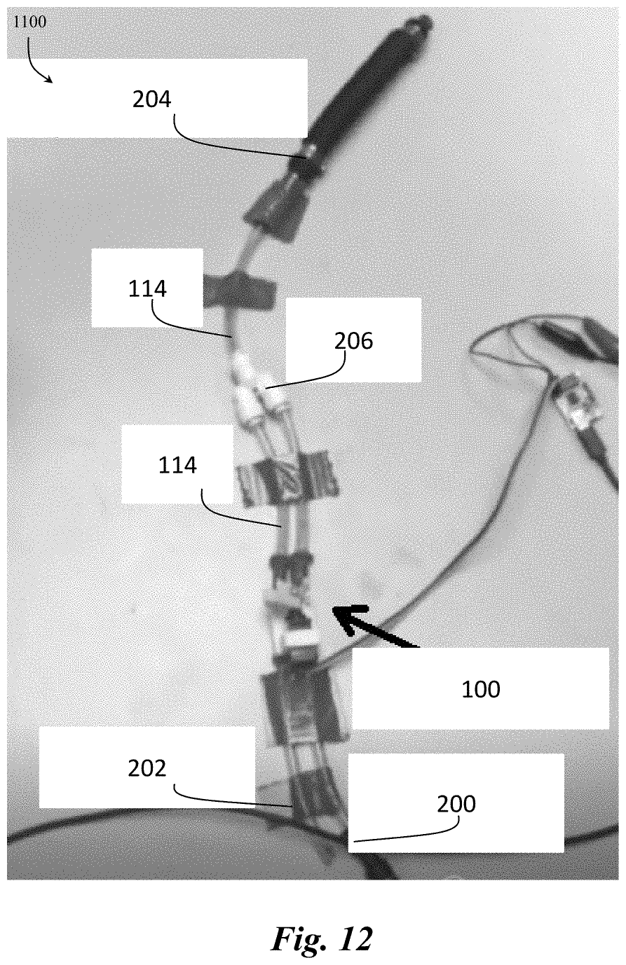

Continuing with FIG. 11, the actuator 204 can be designed to receive and output a fluid flow via the input 200 and output 202 respectively. The input and output to the actuator 204 can share a single line from a port 104 on the structure 102 or can each have their own respective ports 104 on the structure. For example, the actuator 204 can be coupled to two tubes 114 each separately coupled to two ports 104 on a front portion of the structure 102 corresponding to the respective input 200 and output 202. The actuator 204 can also be connected to other elements, such as a Y-connector 206 to combine two tube 114 lines from the structure 102 into a one-directional flow operation for the actuator 204, as shown in FIG. 12. This is an operational configuration of a three-way valve 100, however, due to its mechanical layout, the valve 100 can also be configured as a two-position, parallel, two-way valve (i.e. constrained 4-way valve).

Using the system 1100, the actuator 204 can be provided fluid and have fluid withdrawn therefrom in a controlled manner using the valve 100. In the valve neutral position (symmetric orientation of rotating tensioning element) fluid is not circulating fluid to or from the actuator 204. Depending on direction of tensioning element 106, rotation can cause the valve 100 to either input the fluid from high-pressure fluid input 200 into the actuator 204 or release fluid from the actuator 204 to the low-pressure fluid output 202. The overall system 1100 may be either open (if fluid is vented to environment, and new fluid is supplemented externally) or closed (if same fluid is circulating within the system). The system 1100 can also include any combination of elements needed to operate the valve 100 in accordance with a desired application. For example, the system 1100 can include a power source, a controller, etc. for controlling the valve 100 in accordance with a preferred operation.

Referring to FIG. 12, an illustration of an example system 1100 with a Y-connector 206 and an actuator 204 as discussed with respect to FIG. 11. There are numerous possible applications that the control valve 100 can be used, including applications involving any other valve for fluid (that is various gasses and liquids) based applications to finely regulate fluid flow and then indirectly also pressure, volume, temperature etc. It can be also used to finely mix two different fluids. Hence potential applications range across numerous industries. Still further, similar as pinch valves, due to high elasticity of the rubber that also helps to resist abrasion, the control valve 100 (although primarily designed for fluids, i.e. various gasses and liquids) can be also used on solids such as granules, powders, pellets, chippings, fibers, slivers, any kind of slurries and aggressive products.

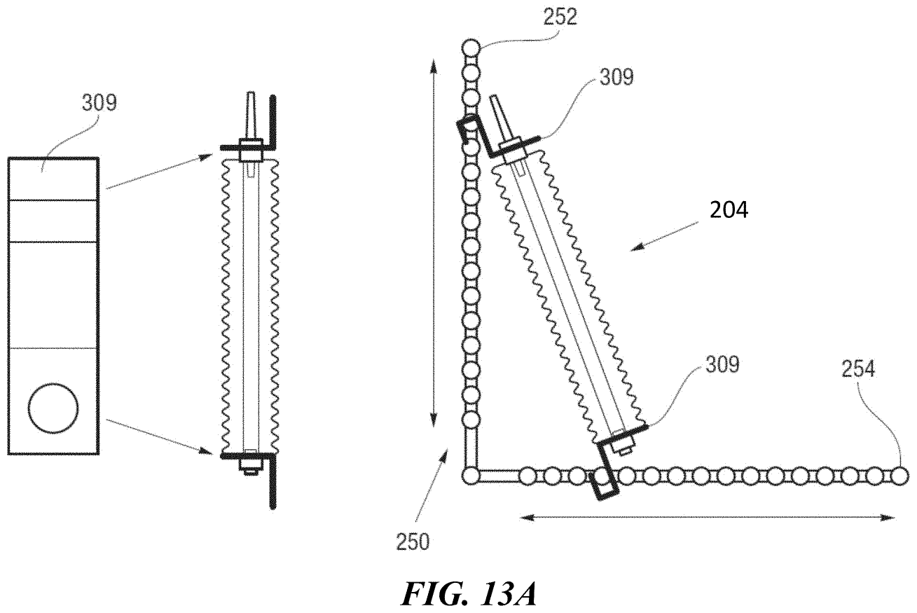

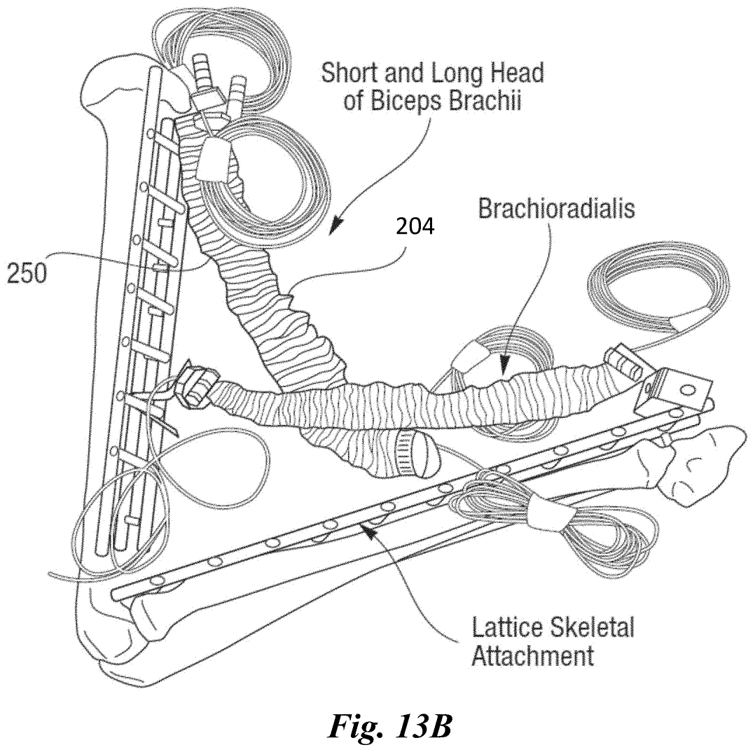

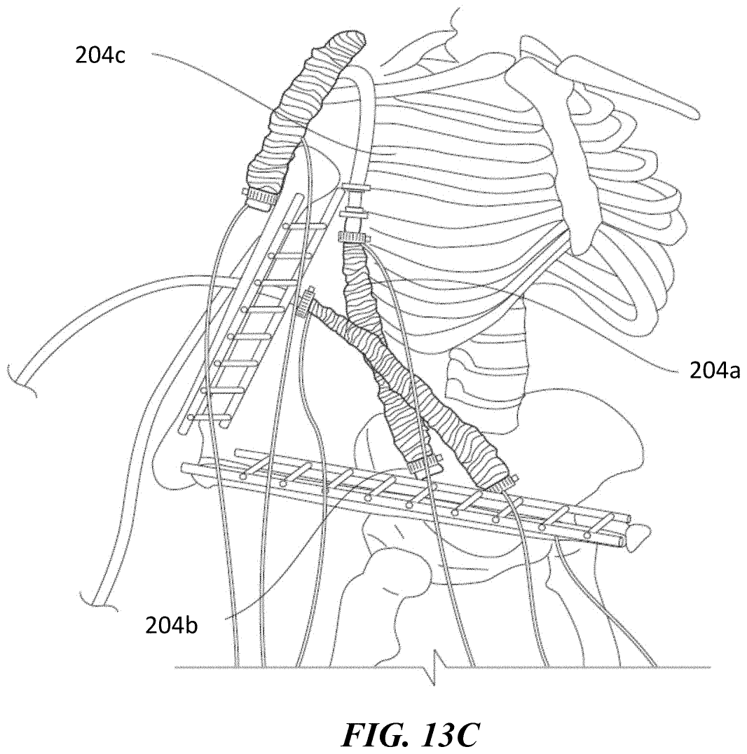

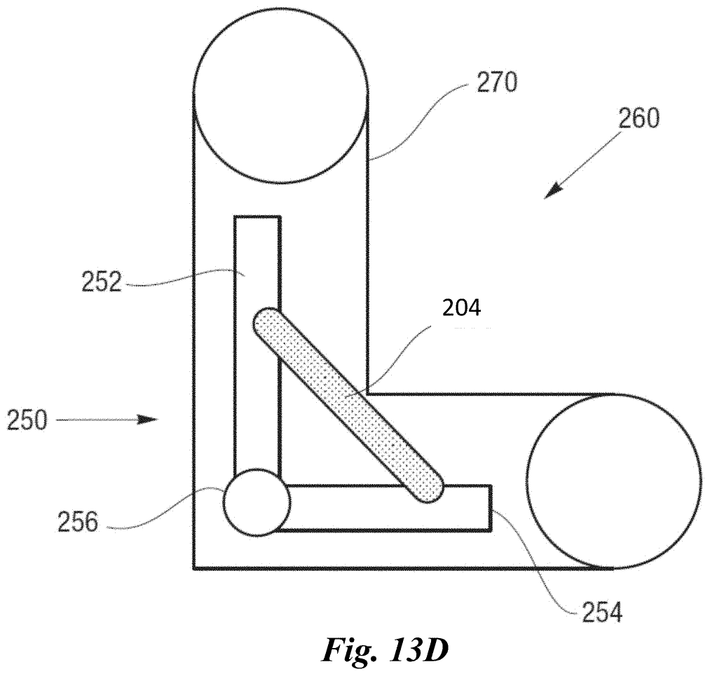

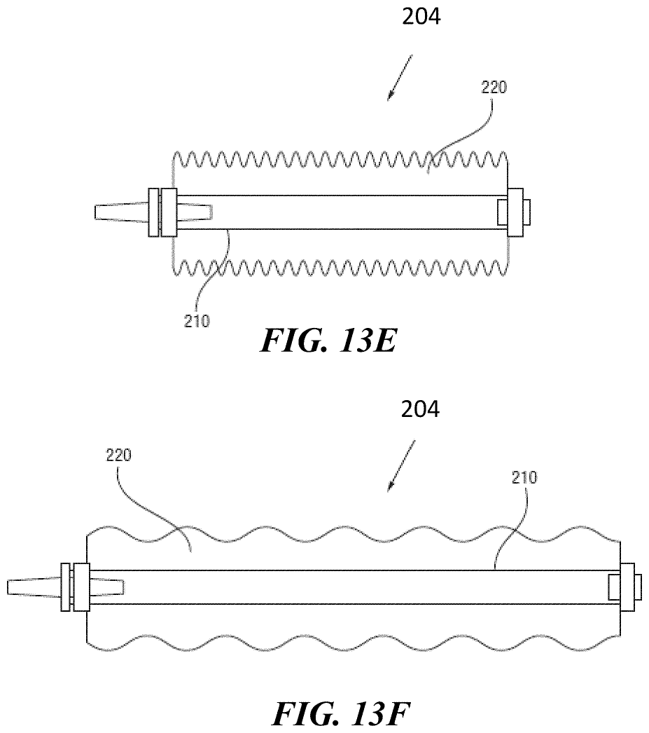

Referring to FIGS. 13A-13D, in some embodiments, the fluid control valve 100 can be used to assist in the fluid flow management for a wearable hydraulic or other fluid or gas operated system. In some embodiments, the instant fluid control valve can be used in a mechanical exo-suit or exoskeleton, for example as discussed with respect to U.S. Pat. No. 10,456,316 incorporated herein by reference in its entirety. In reference to FIG. 13A, FIG. 13B, FIG. 13C, and FIG. 13D, a lattice device 250 powered by the actuator 204 used in conjunction with the valve 100 may be employed as an exoskeleton. In some embodiments, the lattice device 250 may be provided about a user's joint (either internally or externally) to assist the user in moving the limbs of the joint.

For example, FIG. 13A shows the actuator 204 being attached to the lattice device 250 using fasteners 309. The position of the actuator attachment points on the lattice device may be varied up and down the latticed device 250, for example, to control the torque applied on the lattice device 250 by the actuator 204. The fasteners 309 can include cutouts therethrough to assist in attaching the actuator 204 to the lattice device 250. In some embodiments, the fasteners 309 may be a thin sheet metal with cuts into approximately 1 inch by 3 inch pieces and then bent a third of the way down at a 90 degree angle. On one third of the piece, a hole can be drilled so that the cutout could be aligned, concentrically, between one or more adapters for the actuator 204 for a sturdy and permanent attachment. The other half of the cutout can be bent to look like a hook so that it could be fastened around any segment of the latticed device 250. Because of the malleability of the sheet metal, it may be possible to adjust the bend angle so that the open end of the actuator 204 and adapters can stay parallel to maintain the structural integrity of the elastic. At least one aspect to this design may allow for easy detachment and attachment at both ends of the fasteners so the actuator 204 could be arranged in a variety of configurations and at different points on the lattice device 250.

FIG. 13B shows the lattice device 250 fastened to a portion of the skeleton. In reference to FIG. 13C, multiple actuators 204a, 204b, and 204c may be integrated with the lattice device 250 to allow for a skeletal actuator model that can actuate many degrees of freedom. For example, an actuator 204 can be attached as a shoulder flexor of the skeleton so that the model can actuate with two degrees of freedom. Each of the actuators 204a, 204b, 204c can be coupled to one or more valves 100 to individually control each of the actuators 204a, 204b, 204c. Similarly, each of the valves 100 can be connected to one or more inputs 200 and output 202 sources. For example, a single pump can be used to provide fluid flow to each of the valves 100 operating each of the actuators 204a, 204b, 204c. In some embodiments, a single actuator 204 can be connected to single valve 100 that controls the performance of the actuator 204. In some embodiments, there can be multiple actuators 204 that perform simultaneously (i.e., as a group), such that they are not independently controlled and they can also controlled by single valve 100. In some embodiments, two actuators 204 may be employed to actuate the elbow joint of the skeleton, and a third actuator 204 can be used to actuate the shoulder of the skeleton.

In reference to FIG. 13D, to create an exoskeleton joint 260, the lattice device 250 may be combined with a wearable sleeve 270. When the user wears the sleeve 270 about a joint of the user, the members 252, 254 of the lattice device 250 can be positioned substantially along the limbs of the user joint. In this manner, the movement of the lattice members 252, 254 by the actuator 204 may assist the movement of the limbs of the user. In some embodiments, the lattice members 252, 254 may be shaped to conform to the shape of the user's limbs for additional comfort. In some embodiments, multiple lattice devices may be incorporated into a wearable clothing to help movement of multiple joints of the user.

The actuator system of the present disclosure may include one or more sensors, which may, for example, allow sensing the position of a limb actuated by the actuator system. For example, when the actuator 204 is used to function as a bicep, the angle of the fore arm with respect to the upper arm may be sensed. Still further the measurement of electric resistance of actuating fluid within elastic inner member can be utilized to accurately estimate the linear length of the actuator 204 when inner member is fully extended in the radial direction. In some embodiments, the valves 100 within the actuator system can be controlled based on feedback from the one or more sensors. For example, the feedback from the one or more sensors can dictate which motorized units 112 within the valves 100 are activated to open ports 104 and which direction the motorized units 112 provide rotation to open particular ports 104.

The bioinspired exosuit provided in FIGS. 13A-13D used in combination with the valve 100 of the present disclosure provides a cost-effective, energy efficient, fluidly actuated, wearable robotic device that can be used for an accessible/affordable fluid operated wearable robotics solution. These solutions can have numerous applications such as physical therapy and/or assistance with activities of daily living.

Referring to FIGS. 13E and 13F, in some embodiments, the actuator 204 can include an inner member 210 surrounded by an outer member 220. In some embodiments, the inner member 210 forms an elongated, expandable compartment for receiving an actuating fluid from the valve 100. The inner member 210 can thus be moved from a relaxed state to an expanded or pressurized state by introducing the actuating fluid into the inner member 210 and back to the relaxed state upon discharge of the actuating fluid from the inner member 210 by the valve 100. In this manner, the contracting movement of the inner member 210 can be used as an actuating force through fluid transfers provided by the valve 100. In this configuration, the actuator 204 can both pull and push. When an elastic contractile force is due to elongation of an inner member 210 is larger than a force produced by pressure of an actuating fluid, then the actuator 204 is pulling. On the other hand, when the force produced by pressure of an actuating fluid is larger than an elastic contractile force due to the elongation of an inner member 210, then the actuator is pushing. This can remove the necessity for an antagonistic pairing configuration, meaning that a joint can be fully actuated by a single actuator, which can both push and pull.

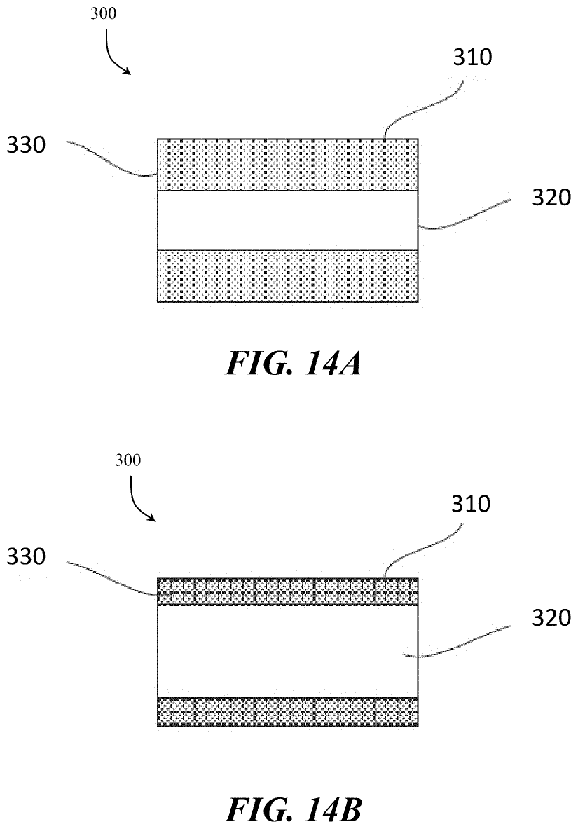

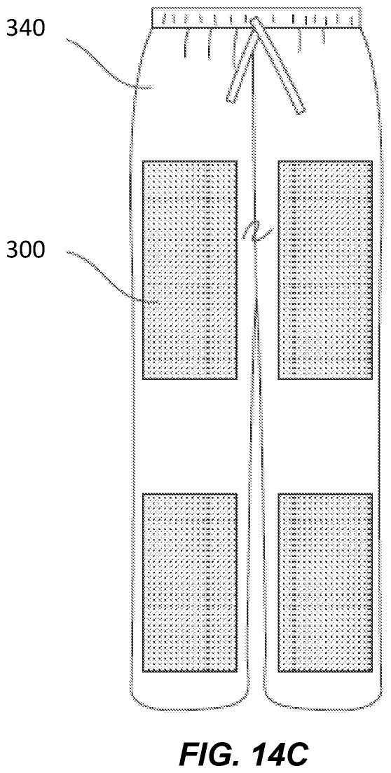

Referring to FIGS. 14A and 14B, in some embodiments, the valve 100 can be coupled to a variable stiffness device 300, for example, in place of actuator 204 in system 1100. In some embodiments, the variable stiffness device 300 can include an inner member 320 surrounded by an outer member 310 with a layer of granular medium 330 disposed between the inner member 320 and the outer member 310. In some embodiments, the inner member 320 can form an elongated, expandable compartment for receiving an actuating fluid from the valve 100. The inner member 420 can thus be moved from a relaxed state, as shown in FIG. 14A, to an expanded or pressurized state, as shown in FIG. 14B, by introducing the actuating fluid into the inner member 420 by the valve 100. Similarly, the inner member 420 can be transitioned back to the relaxed state upon discharge of the actuating fluid from the inner member 320 by the valve 100. Pressurizing the inner member 320 may expand the inner member 320 in the radial direction, longitudinal direction or both. As the inner member expands, it may compress the granular medium against the outer member to change the stiffness of the variable stiffness device 300. When the inner member 320 is not pressurized or pressurized at small fluid pressure applied by the valve 100, the inter granular distance can be large enough that granules can easily pass next to each other such that the structure is easily bendable and characterized with small stiffness. On the other hand, at higher pressures, the inter granular distance is small, i.e. granular media is jammed such that structure is rigid and characterized with large stiffness.

Referring to FIG. 14C, in some embodiments, one or more variable stiffness devices 300 of the present disclosure may be combined with a wearable article of clothing 340, to form an exoskeleton, as discussed in U.S. Pat. No. 10,028,855 incorporated herein by reference. Along with each of the stiffness device 300 incorporated within the article of clothing 340, one or more valves 100 will be incorporated therein to control pressurization and depressurization of each of the stiffness devices 300. When the user wears the article of clothing 340, the one or more variable stiffness devices 300 can be positioned substantially along the clothing to best provide support to the user in the manner of representing an artificial bone. For example, the stiffness devices 300 may help support or protect user's joints when carrying a load. In some embodiments, the stiffness devices 300 may be shaped to conform to the shape of the user's limbs for additional comfort. In some embodiments, multiple stiffness devices 300 may be incorporated into a wearable clothing 340 to help protect multiple joints of the user. In some embodiments, the stiffness devices 300, when combined with valves 100 and a wearable article of clothing 340, are configured to have a light support structure, i.e. variable shape and stiffness, utilizing the stiff, variable stiffness devices 300, which can be tuned “on the fly” to transition from being a very stiff, rigid support to a completely soft, bendable material. The size and shape can also be also tuned during operation. The exoskeleton device 340 may be adjustable for specific users and/or intended tasks of specific users.

### EXAMPLES

Experiment

A simple tensioning element (‘leg’) was attached with a pin joint to a fixed base and actuated by an actuator 204. A desired ‘leg’ angular trajectory was specified in the form of absolute value of the sine function over period of 2π seconds. A simple proportional, dead-band adjusted controller was developed for control of the servo motor (e.g., motorized unit 112). The ‘leg’ angular displacement values were provided by a potentiometer. The same test was performed with κ-way pneumatic solenoid valve, which utilized a custom, pseudo-analog, PWM loop with a cycle time of 5 ms and a tuned P-controller.

For the air test, an air compressor maintained a constant pressure of 0.69 MPa (100 psi), and the exhaust was vented into the ambient space. For the water test, a 12V pump with an accumulator maintained steady fluid pressure in closed loop hydraulic system.

Test Parameters

1) Response Time: To test system response time, end-stops were placed at the valve 100 maximal operational angle and neutral position. Contact with these end-stops triggered or stopped an internal timer for the channel open and channel close movement at 100 psi of fluid pressure. Ten tests were recorded for both air and water.

2) Flow Rate: The flow rate across a range of servo angles was determined by taking the steady state flow rate readings at 6 degree increments from 0 (fully closed) to 42 degrees (fully open). The test setup for air consisted of a compressed air reservoir connected to a valve inlet and a digital anemometer at the outlet. Similarly, the test setup for water consisted of a 12V diaphragm pump connected to a valve inlet and a digital paddle-wheel flow meter at the outlet.

3) Actuator speed: To address the servo angle in relation to the actuators elongation speed, the rate of elongation was collected with the curved valve attachment being rotated at various degrees and timing the full elongation of a 10.4 cm actuator in contracted state.

4) Controllability: The controllability of the valve 100 using both air and water were evaluated with the test setup seen in FIG. 9.

Result Summary

1) Response Time: The valve 100 exhibits a relatively fast response time with very little difference between water and air mediums.

Based on reviews of commercially available valves, the quick response times for fully opening and fully closing of 4-8 mm inner diameter, commercially available, pilot solenoid valves operating at −100 PSI air pressure range from 10 ms to 20 ms and 20 ms to 80 ms respectively. In the case of liquids these ranges are typically 15 ms to 30 ms, and 30 ms to 120 ms respectively.

In comparison, the full closing and opening times for valve 100 using the same conditions are approximately 65 ms for air and 70 ms for water. Additionally, the valve 100 allows for continuous fine control of flow. The valve 100's speed is well suited for wearable robotic actuation systems, as it takes about 250 ms for a skeletal biological muscle to develop a peak force.

2) Flow Rate: The valve 100 flow is reasonably large with >2.5 l/min and >2×10⁵ l/min for water and air respectively. The flow can be increased by using different tube dimensions. The flow results exhibit a 6° deadband angle, which addresses potential servo inaccuracies and introduces control delays. Before it saturates, the flow is roughly proportional to valve angle.

3) Actuator speed: The result of the test relating servo angle to the actuator 204 elongation speed exhibits an R²-value of 0.967. There is a strong linear relationship between flow rate and servo angle. This largely linear behavior is a characteristic of an optimized valve design. This linear control of the flow allows for better control of the actuator 204 than a conventional on-off solenoid valve.

4) Controllability: The valve 100 operating with air has a more precise and accurate tracking than a conventional 5-way on-off solenoid valve. There was significantly less oscillation in the valve 100 tests when compared to a conventional solenoid valve due to the valve 100 mechanism preventing sharp, jerky movements.

From the response tests of the valve 100, it is clear that the choice of fluid impacts the response of the system, however, the valve 100 is still able to follow the desired trajectories in a smooth and controlled manner.

As a conclusion of this testing, the valve 100 of the present disclosure provides a low cost, lightweight, compact, valve that has capabilities for fine control and customization and can be electronically controlled, and can support a reasonable range of pressures appropriate for wearable robotics applications.

As utilized herein, the terms “comprises” and “comprising” are intended to be construed as being inclusive, not exclusive. As utilized herein, the terms “example”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the disclosure. It is intended that the present disclosure be limited only to the extent required by the appended claims and the applicable rules of law.

It is also to be understood that the following claims are to cover all generic and specific features of the disclosure described herein, and all statements of the scope of the disclosure which, as a matter of language, might be said to fall therebetween.

1. A fluid flow control valve device, the device comprising:
a support structure;
one or more fluid tubes associated with the support structure;
a tensioning element supported by the support structure and being rotatable about an axis point relative to the support structure in response to an application of force; and
one or more threads, each extending between the tensioning element and the one or more fluid tubes, the one or more threads configured to provide sufficient tension to compress at least one of the one or more fluid tubes in response to tension generated due to the rotation of the tensioning element.

2. The device of claim 1, further comprising a one or more ports, each configured to receive at least one of the one or more fluid tubes to establish a continuous fluid flow through the device when a fluid tube is uncompressed.

3. The device of claim 1, wherein each of the one or more threads comprises a pair of loops coupled together.

4. The device of claim 3, wherein each pair the loops are coupled together using a barrel clasp.

5. The device of claim 1, wherein the one or more fluid tubes further comprise outer sheathing to protect the fluid tubes from damage when under tension by the one or more threads.

6. The device of claim 1, wherein the support structure further comprises one or more control access points through which the one or more threads extend through to around an exterior surface of one of the one or more fluid tubes.

7. The device of claim 1, wherein the one or more threads extend around an exterior surface of the one or more fluid tubes.

8. The device of claim 1, wherein:
the one or more fluid tubes is compressed by the one or more threads when the tensioning element is in a neutral state; and
at least one of the one or more fluid tubes is uncompressed by at least one of the threads when the tensioning element is rotated about the axis point.

9. The device of claim 1, further comprising one or more beads positioned on a surface of the tensioning element, the one or more beads configured to move along the surface of the tensioning element when the force is applied to the tensioning element.

10. The device of claim 9, wherein each of the one or more threads are connected to one of the one or more beads.

11. A method for controlling fluid flow through a control valve, the method comprising:
coupling a first end of at least one fluid tube to a reservoir including a fluid and second end of the at least one fluid tube to a fluid flow control valve, the fluid flow control valve comprising:
a tensioning element supported by the support structure and being rotatable about an axis point relative to a support structure in response to an application of force; and
at least one thread extending between the tensioning element and the at least one fluid tube, the least one thread configured to provide sufficient tension to compress the at least one fluid tube in response to tension generated due to the rotation of the tensioning element; and
rotating the tensioning element in a first direction to cause the at least one thread to reduce the tension applied to the at least one fluid tube; and
wherein the reduced tension is sufficient to allow fluid to flow between the reservoir and the fluid flow control valve through the at least one fluid tube.

12.-15. (canceled)

16. A system for hydraulically assisted wearable clothing, the system comprising:
a reservoir including an actuating fluid;
multiple actuators;
a fluid flow control valve in communication with the reservoir and the actuators for selectively supplying the actuating fluid to the actuators, the fluid flow control valve comprising:
a support structure;
one or more fluid tubes associated with the support structure;
a tensioning element supported by the support structure and being rotatable about an axis point relative to the support structure in response to an application of force; and
one or more threads, each extending between the tensioning element and the one or more fluid tubes, the one or more threads configured to provide sufficient tension to compress at least one of the one or more fluid tubes in response to tension generated due to the rotation of the tensioning element;
wherein, when an actuator of the multiple actuators is pressurized by the fluid flow control valve to move the inner member to its expanded state, the pressurized actuator expands in the axial direction, and
wherein, when an actuator of the multiple actuators is de-pressurized by the fluid flow control valve to return the inner member to its relaxed state, the de-pressurized actuator contracts in the axial direction; and
a controller in communication with the fluid flow control valve to control operation of the fluid flow control valve and pressurization and de-pressurization of the multiple actuators.

17. The system of claim 16, further comprising a rotary selector disposed between the fluid flow control valve and the actuators to enable the fluid flow control valve to selectively supply the actuating fluid to the actuators.

18. The system of claim 16, further comprising a one or more ports, each configured to receive at least one of the one or more fluid tubes to establish a continuous fluid flow through the device when a fluid tube is uncompressed.

19. The system of claim 16, wherein each of the one or more threads comprises a pair of loops coupled together.

20. The system of claim 16, wherein each pair the loops are coupled together using a barrel clasp.

21. The system of claim 16, wherein the one or more fluid tubes further comprise outer sheathing to protect the fluid tubes from damage when under tension by the one or more threads.

22. The system of claim 16, wherein the support structure further comprises one or more control access points through which the one or more threads extend through to around an exterior surface of one of the one or more fluid tubes.

23.-27. (canceled)

28. An exoskeleton comprising:
a wearable sleeve;
a first member and a second member combined with the wearable sleeve, the second member being pivotably connected to the first member;
an actuator connected to the first member at a first end of the actuator and to the second member at a second end of the actuator;
a fluid flow control valve in communication with the reservoir and the actuators for selectively supplying the actuating fluid to the actuators, the fluid flow control valve comprising:
a support structure;
one or more fluid tubes associated with the support structure;
a tensioning element supported by the support structure and being rotatable about an axis point relative to the support structure in response to an application of force; and
one or more threads, each extending between the tensioning element and the one or more fluid tubes, the one or more threads configured to provide sufficient tension to compress at least one of the one or more fluid tubes in response to tension generated due to the rotation of the tensioning element;
wherein, when the actuator is pressurized by the fluid flow control valve to move the actuator to its expanded state, the actuator expands in the axial direction, and
wherein, when the actuator is de-pressurized by the fluid flow control valve to return the actuator to its relaxed state, the actuator contracts in the axial direction to cause a movement of at least one of the first member and the second member relative to the other member.

29-41. (canceled)
